(19) United States
(12) Patent Application Publication
(10) Pub. No.: US 2021/0097780 A1
(43) Pub. Date: Apr. 1, 2021

(54) METHOD AND SYSTEM FOR DETERMINING ADVANCED DRIVER ASSISTANCE SYSTEMS (ADAS) FEATURES

(71) Applicant: AUTO RECORDS LTD, Co. Kildare (IE)

(72) Inventors: Jeff Aherne, Co. Kildare (IE); John Byrne, Co. Kildare (IE)

(21) Appl. No.: 17/042,089

(22) PCT Filed: Jan. 30, 2019
(86) PCT No.: PCT/EP2019/052204

§ 371 Date: Sep. 25, 2020

(30) Foreign Application Priority Data
Mar. 28, 2018 (GB) 1804972.6

(51) Int. Cl. G07C 5/00; G05D 1/02; H04L 29/08; G06K 9/32

(52) U.S. Cl. CPC G07C 5/008; G05D 1/0276; G06K 2209/15; G06K 9/325; H04L 67/12

(57) ABSTRACT

Provided are a method and system for determining Advanced Driver Assistance Systems (ADAS) features in a first vehicle, the method comprising operating a computing device configured to:receive one or more identifiers of the first vehicle; identify the first vehicle based on the one or more identifiers; and determine from a vehicle database whether the identified first vehicle has ADAS features.

### FIELD OF THE INVENTION

The present disclosure relates to Advanced Driver Assistance Systems (ADAS). More particularly, it relates to a method and system for autonomous vehicles to determine Advanced Driver Assistance Systems (ADAS) features of other vehicles in their environment.

### BACKGROUND OF THE DISCLOSURE

Advanced driver assistance systems (ADAS) function to automate, adapt and/or enhance vehicle systems for safety and better driving by a human driver. Safety features are designed to avoid collisions and accidents by offering technologies that alert drivers to potential problems, or to avoid collisions by implementing safeguards and ultimately taking over control of the vehicle from the human driver. Adaptive features may automate lighting, provide adaptive cruise control, automate braking, incorporate GPS/traffic warnings, connect to smart devices, alert drivers to other vehicles or dangers, keep the driver in the correct lane, or show what is in blind spots.

Automatic number-plate recognition (ANPR) is a technology that uses optical character recognition of images to read vehicle registration plates. ANPR can use existing closed-circuit television, road-rule enforcement cameras, or cameras specifically designed for the task. ANPR is used by police forces for law enforcement purposes, including to check if a vehicle is registered or licensed. It is also used for electronic toll collection on pay-per-use roads and as a method of cataloguing the movements of traffic, for example by highways agencies. ANPR cameras currently rely on retrieval of a full vehicle registration number from the vehicle registration plate for identification of the vehicle, and otherwise return a null response.

Autonomous vehicles are vehicles that are capable of sensing their environment and navigating without human input. Autonomous vehicles use a variety of techniques to detect their surroundings, such as radar, laser light, GPS, odometry and computer vision. Advanced control systems function to interpret sensory information to identify appropriate navigation paths, as well as obstacles and relevant signage. Autonomous vehicles must have control systems that are capable of analyzing sensory data to distinguish between different vehicles on the road. There are five levels of autonomy ranging from Level 0—Automated system issues warnings and may momentarily intervene but has no sustained vehicle control, to Level 5—No human intervention is required. Highly Autonomous Vehicles (HAV) are classified as Level 4 and above. HAVs do not use ADAS as ADAS are driver assistance features designed to assist a human driver and a HAV does not require a human driver. Highly Autonomous Vehicles (HAV) read the position of other objects within their ambit using a light detection and ranging function known as Lidar which sits on the vehicle and communicates the position of other vehicles to determine distances, obstructions, hazards and permits HAVs to change speed or direction as required to comply with local road traffic regulations and road user safety.

In view of the above-described technologies, there is a need for an improved system for HAVs to adapt to different vehicles which are not highly autonomous and to other obstacles in their vicinity.

### SUMMARY OF THE INVENTION

These and other problems are addressed by providing a method as detailed in claim 1 and a system as detailed in claim 21. Advantageous features are provided in dependent claims.

Generally, the present disclosure provides a method and system for autonomous vehicles to establish the ADAS features of non-autonomous vehicles in their environment. In one embodiment, the method and system of the present disclosure applies an ANPR solution to differentiate between the individual attributes of a particular vehicle in the ambit of a HAV other than physical attributes. The method and system of the present disclosure can supply critical data to a HAV via an advanced ANPR system which allows the HAV to differentiate between vehicles within its physical ambit which have ADAS features over vehicles which do not have ADAS features and to communicate in real time those features to the HAV.

These and other features will be better understood with reference to the following figures which are provided to assist in an understanding of the present teaching, by way of example only.

### BRIEF DESCRIPTION OF THE DRAWINGS

FIG. 1 is a flowchart illustrating a method of determining Advanced Driver

Assistance Systems (ADAS) features, according to an embodiment of the present disclosure;

FIG. 2 is a block diagram illustrating a system for determining Advanced Driver Assistance Systems (ADAS) features, according to an embodiment of the present disclosure; and

FIG. 3 is a block diagram illustrating a configuration of a computing device which includes various hardware and software components that function to perform processes according to embodiments of the present disclosure.

### DETAILED DESCRIPTION

Embodiments of the present disclosure will now be described with reference to some exemplary apparatus and systems described herein. It will be understood that the embodiments described are provided to assist in an understanding of the present disclosure and are not to be construed as limiting in any fashion. Furthermore, modules or elements that are described with reference to any one figure may be interchanged with those of other figures or other equivalent elements without departing from the spirit of the present disclosure.

Highly Autonomous Vehicles (HAV) are configured with the capability to self-drive by Original Equipment Manufacturers (OEM) and are capable of this autonomous driving via Vehicle to External (V2X) or Vehicle to Vehicle (V2V) communication.

The present disclosure provides a method and system for determining Advanced Driver Assistance Systems (ADAS) features in a first vehicle, the method comprising operating a computing device configured to: receive one or more identifiers of the first vehicle; identify the first vehicle based on the one or more identifiers; and determine from a vehicle database whether the identified first vehicle has ADAS features. The method may be used for autonomous vehicles to establish the ADAS features of non-autonomous vehicles in their environment. For example, a HAV may determine the ADAS features of the first vehicle which is within the ambit of the HAV.

The computing device may reside on a cloud-based computer. The method may comprise transmitting the result of determining whether the identified first vehicle has ADAS features to a second vehicle. The second vehicle may communicate with the computing device via a Vehicle-to-External (V2X) communication capability. The second vehicle may also communicate with the vehicle database via a Vehicle-to-External (V2X) communication capability. The second vehicle may be a Highly Autonomous Vehicle (HAV). The result of determining whether the identified first vehicle has ADAS features may comprise determining that the first vehicle is a Highly Autonomous Vehicle (HAV), in which case the first vehicle does not have ADAS features. The result of determining whether the identified first vehicle has ADAS features may comprise determining that the first vehicle is a vehicle equipped with ADAS which is not a HAV, or a vehicle which is not equipped with ADAS and which is not a HAV.

In another embodiment, the second computing device may be disposed in the second vehicle. In this embodiment, the method may comprise receiving the result of determining whether the identified first vehicle has ADAS features at the second vehicle.

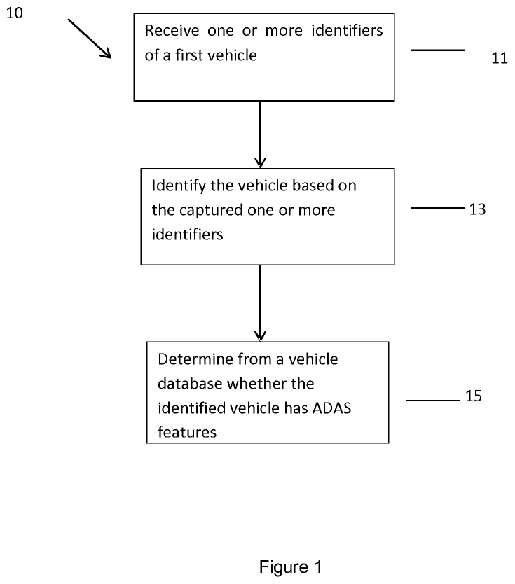

FIG. 1 is a flowchart illustrating a method 10 of determining Advanced Driver

Assistance Systems (ADAS) features, according to an embodiment of the present disclosure. Referring to FIG. 1, the method 10 comprises: receiving one or more identifiers of a vehicle 11; identify the vehicle based on the one or more identifiers 13; and determine from a vehicle database whether the identified vehicle has ADAS features 15.

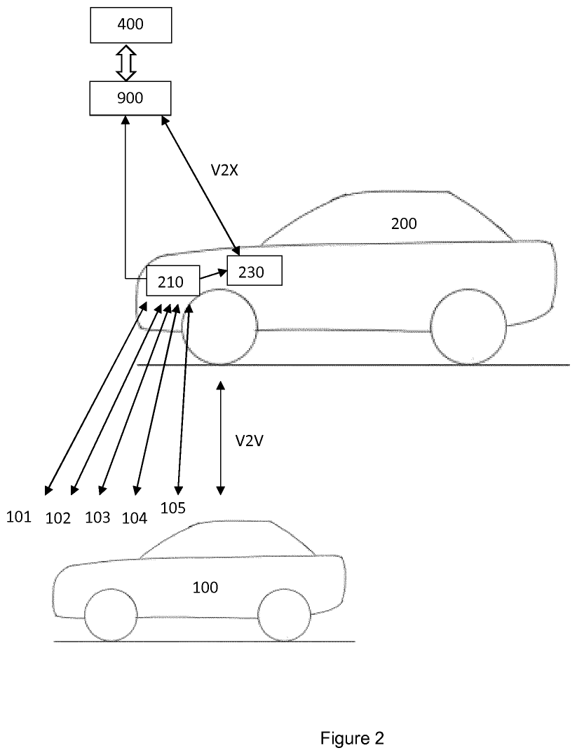

FIG. 2 is a block diagram illustrating a system for determining ADAS features, according to an embodiment of the present disclosure. Referring to FIG. 2, the system 100 may comprise an ANPR imaging device 210 installed in a second vehicle 200. The second vehicle 200 may be a Highly Autonomous Vehicle (HAV). The ANPR imaging device 210 is configured to capture one or more identifiers of a first vehicle 100. Referring to FIG. 2, the one or more identifiers of the first vehicle 100 may comprise a full vehicle registration number 101, vehicle make 102, vehicle model 103, vehicle colour 104, and a partial vehicle registration number 105. A computing device 900 is configured to communicate with the ANPR imaging device 210. The computing device 900 is configured to receive the one or more identifiers of the first vehicle 100 and identify the first vehicle 100 based on the captured identifiers. In this regard, the computing device 900 may comprise one or more processors for performing the processing tasks. The computing device 900 may reside on a cloud-based computer as described later. ADAS features, and optionally critical technical data, for the identified first vehicle 100 may be obtained from a vehicle database 400. The vehicle database 400 may also reside on a cloud-based computer. A sufficient number of identifiers of the first vehicle 100 may enable the computing device 900 to interrogate the vehicle database 400 to identify the first vehicle 100. Once the first vehicle 100 is identified, it is determined whether the first vehicle 100 has ADAS features or not. The result of determining whether the identified first vehicle 100 has ADAS features may be transmitted to the second vehicle 200 via a Vehicle-to-External (V2X) communication capability. The result of determining may be transmitted in real time or transmitted regularly by the computing device 900 to the second vehicle 200. The ADAS features of the first vehicle 100 may be transmitted to the second vehicle 200, for example to a computing device 230 of the second vehicle 200. In this regard, it will be understood that the computing device 230 of the second vehicle 200 is a computing device comprising at least one processor such as an Engine Control Unit (ECU). In this regard, if it is determined that the first vehicle 100 has ADAS features, this determination may be transmitted to the computing device 230 of the second vehicle 200.

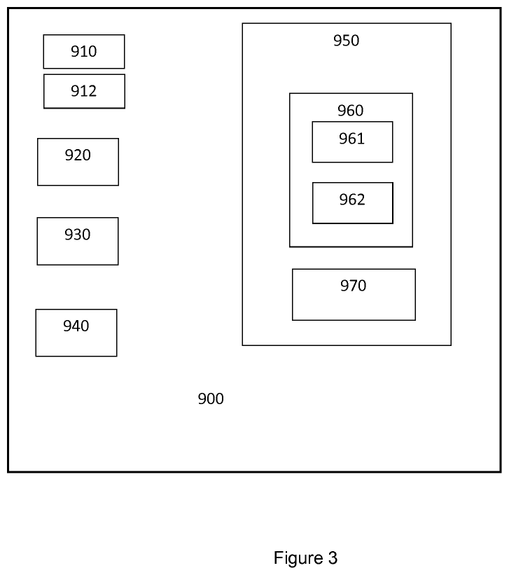

In another embodiment, instead of the second vehicle 200 receiving information, including ADAS information, from a cloud-based computer via V2X communication capability, the second vehicle 200 may receive information, including ADAS information, from the first vehicle 100 directly via a Vehicle-to-Vehicle (V2V) communication capability. In this embodiment, the second vehicle 200 does not require an ANPR imaging device. In this regard, the first vehicle 100 may have been pre-fitted with a communication device. In this embodiment, the computing device 230 disposed in the second vehicle 200 may perform the processing functions to identify the first vehicle 100 and determine ADAS features of the first vehicle 100. In this embodiment, it will be understood that the computing device 900 illustrated in FIG. 3 corresponds to the computing device 230 as illustrated in FIG. 2.

The vehicle database 400 may comprise a list of Vehicle Identification Numbers (VIN) cross-referenced to Vehicle Manufacturer Data. The vehicle database 400 may comprise vehicle makes and models with ADAS attributes. The vehicle database 400 may comprise vehicle makes and models with no ADAS attributes. In effect, a vehicle dataset stored in the vehicle database 400 corresponding to the first vehicle 100 may be made available to the second vehicle 200 via software which reads the results of an ANPR system via the ANPR imaging device 210 mounted in the second vehicle 200. The ANPR system comprises the ANPR imaging device 210 and an ANPR processor. The ANPR imaging device 210 and the ANPR processor may be integral in the second vehicle 200. In a preferred embodiment, the ANPR imaging device 210 is disposed in the second vehicle 200 and the ANPR processor is located in the computing device 900.

The ANPR system adopts an Optical Character Recognition system configured to read the vehicle registration plate of the first vehicle 100, or any other stationary or moving vehicle around the second vehicle 200. The ANPR system may also be configured to determine the make and model attributes, year of manufacture and colour of the first vehicle 100 or any other adjacent stationary or moving vehicle. The one or more identifiers of the first vehicle 100 may comprise one or more of a full or partial vehicle registration number, make, model, and colour of the vehicle. The ANPR system may require at least two visible digits of the vehicle registration plate to help identify the first vehicle 100. The first vehicle 100 may be identified based on a partial vehicle registration number and at least one other identifier comprising a make, model, and colour of the vehicle. The first vehicle 100 may be identified as having a Vehicle Identification Number (VIN). A list of VINs is stored in the vehicle database 400. A VIN is a unique code, including a serial number, used by the automotive industry to identify individual motor vehicles, towed vehicles, motorcycles, scooters and mopeds, as defined in ISO 3779:2009. The ANPR system may also be configured to measure the tread-depth of any visible tyre on the first vehicle 100. That is, the ANPR imaging device 210 may be configured to capture the tread-depth of any visible tyre on the first vehicle 100. The ANPR processor may be configured to determine the tread-depth based on the captured image of the tread-depth. The determined tread depth helps determine stopping distances.

The datasets stored in the vehicle database 400 may be compiled by acquiring original Vehicle Manufacturer Data and compiling a list of ADAS features for each make and model of vehicle. This results in a list of different vehicle types with ADAS attributes according to make and model. The list may also include vehicle makes and models with no ADAS attributes. This list may then be further differentiated into two streams: vehicle makes and models where the ADAS attributes are standard and vehicle makes and models where the ADAS features are optional.

In cases where the ADAS features are optional, each individual vehicle of that make and model manufactured may be identified by its Vehicle Identification Number (VIN) and cross-referenced to its original manufacturer build sheet in the case of each vehicle to identify which vehicle was actually manufactured with ADAS features.

This results in a list of vehicles manufactured with ADAS features by VIN number which is matched to the Vehicle Registration Number for each vehicle. Other vehicular specifications may be applied to the data held in the dataset for each vehicle. Such specifications may include vehicle dimensions, vehicle weight, power, acceleration, vehicle stopping distance in different weather conditions, and most recent change of owner of vehicle.

The data for the first vehicle 100 stored in the database 400 may be made available to the computing device 230 of the second vehicle 200 via software which reads the data retrieved via the ANPR system comprising the ANPR imaging device 210 on the second vehicle 200.

Accordingly, an ANPR solution may be applied to differentiate between the individual attributes of a particular vehicle in the ambit of the first vehicle 100 other than physical attributes.

The method and system of the present disclosure permits a HAV to have full visibility of the ADAS features of a vehicle within its ambit. This has various implications as follows. By virtue of the methodology of the present disclosure, the HAV can differentiate between vehicles which have ADAS features over vehicles which do not have ADAS features. The HAV can determine what ADAS features are available to any vehicle within its ambit. Such determination permits the HAV to estimate with accuracy how that vehicle will react in the event the HAV requires a sudden change of direction or speed to avoid a collision with another vehicle which has ADAS features or which does not have ADAS features or any other obstacle. The HAV can determine if any vehicle within its ambit requires human intervention or does not require human intervention in any particular instance involving a sudden change of direction or speed to avoid a collision with another vehicle with ADAS features or which does not have ADAS features or with any other obstacle. The HAV can determine the gross vehicle weight and dimensions of any vehicle within its ambit, which allows the HAV to estimate the stopping distance of that vehicle. The HAV can determine the estimated stopping distance of any vehicle within its ambit in a particular weather condition, which allows the HAV to estimate the stopping distance of that vehicle. The HAV can determine whether there has been effected a recent change of ownership of any vehicle within its ambit. If it has been determined that there has been a recent change of ownership of a vehicle, the HAV can make adjustments for the likelihood that a novice driver unfamiliar with the vehicle is in control of that vehicle. As the ANPR system may be configured to measure the tread-depth of any visible tyre on the first vehicle 100, the HAV can consequently make adjustments when determining the estimated stopping distance of the first vehicle 100. As a result of identifying any vehicles within its ambit, the HAV can determine the exact dimensions of such vehicles which can assist with overtaking manoeuvres of the HAV. Access to acceleration data of another vehicle will help the HAV to determine how quickly another vehicle may engage in an overtaking manoeuvre. Access to the dimensions of other vehicles within the ambit of the HAV can also assist with parking of the HAV. Determining the gross vehicle weight and vehicle dimensions of a vehicle within its ambit can assist the HAV to determine the likely damage to another vehicle immediately following an impact between the HAV and that other vehicle and to send that information to emergency services. This has application in the case of emergency assistance features which automatically communicate road traffic collisions to emergency services. Currently in the event of collisions, only information about the vehicle sending the information is sent to the emergency services. All data from the impact between the HAV and that other vehicle can be stored as a repository of information. The data can be recalled by a HAV in future when an identical impact involving the same vehicle types is imminent, meaning the information can be used in real time decision-making of the HAV prior to an impact. This adds to the repository of information available to HAV software engineers charged with the responsibility of coding for HAV responses in emergency situations. Determining the make and model of the vehicle in front of the HAV will determine whether that other vehicle is a bus and whether that vehicle is likely to have to stop at a bus stop nearby. Access to vehicular information of the other vehicle will assist the HAV to determine which lights on the rear of a vehicle in front of the HAV are the brake lights of that vehicle.

The method and system of the present disclosure permits a HAV to have a greater understanding of the vehicles in its ambit and permits the HAV to make requisite adjustments to its speed and direction in the event the HAV requires a sudden change of direction or speed to avoid a collision with another vehicle which has ADAS features or which does not have ADAS features or any other obstacle.

The method and system of the present disclosure employs an ANPR imaging device configured to read both the vehicle registration plate of any stationary or moving vehicle around a HAV and also the make and model attributes and year of manufacture and colour of any stationary or moving vehicle around the HAV.

This permits both a full and a partial reading of any vehicle registration plate to trigger a response via the camera and retrieve the relevant vehicle information from the dataset.

The method and system of the present disclosure may become requisite for all OEMs which supply software solutions to a HAV.

FIG. 3 is a block diagram illustrating a configuration of the computing device 900 of FIG. 2. The computing device 900 includes various hardware and software components that function to perform processes according to the present disclosure. The computing device 900 may be embodied as one of numerous general purpose or special purpose computing system environments or configurations. Examples of well-known computing systems, environments, and/or configurations that may be suitable for use with the present disclosure include, but are not limited to, personal computers, server computers, cloud computing, hand-held or laptop devices, multiprocessor systems, microprocessor, microcontroller or microcomputer based systems, set top boxes, programmable consumer electronics, ASIC or FPGA core, DSP core, network PCs, minicomputers, mainframe computers, distributed computing environments that include any of the above systems or devices, and the like.

Referring to FIG. 3, the computing device 900 comprises a user interface 910, a processor 920 in communication with a memory 950, and a communication interface 930. The processor 920 functions to execute software instructions that can be loaded and stored in the memory 950. The processor 920 may include a number of processors, a multi-processor core, or some other type of processor, depending on the particular implementation. The processor 920 may include an ANPR processor. The memory 950 may be accessible by the processor 920, thereby enabling the processor 920 to receive and execute instructions stored on the memory 950. The memory 950 may be, for example, a random access memory (RAM) or any other suitable volatile or non-volatile computer readable storage medium. In addition, the memory 950 may be fixed or removable and may contain one or more components or devices such as a hard drive, a flash memory, a rewritable optical disk, a rewritable magnetic tape, or some combination of the above.

One or more software modules 960 may be encoded in the memory 950. The software modules 960 may comprise one or more software programs or applications having computer program code or a set of instructions configured to be executed by the processor 920. Such computer program code or instructions for carrying out operations for aspects of the systems and methods disclosed herein may be written in any combination of one or more programming languages.

The software modules 960 may include at least a first application 961 and a second application 962 configured to be executed by the processor 920. During execution of the software modules 960, the processor 920 configures the computing device 900 to perform various operations relating to the embodiments of the present disclosure, as has been described above.

Other information and/or data relevant to the operation of the present systems and methods, such as a database 970, may also be stored on the memory 950. The database 970 may contain and/or maintain various data items and elements that are utilized throughout the various operations of the system described above. It should be noted that although the database 970 is depicted as being configured locally to the computing device 900, in certain implementations the database 970 and/or various other data elements stored therein may be located remotely. Such elements may be located on a remote device or server—not shown, and connected to the computing device 900 through a network in a manner known to those skilled in the art, in order to be loaded into a processor and executed. In FIG. 2, the vehicle database 400 is illustrated as being remote to the computing device 900, but it will be understood that the vehicle database 400 may be integral with the computing device 900. In such an embodiment, the database 970 may comprise the vehicle database as described above.

Further, the program code of the software modules 960 and one or more computer readable storage devices (such as the memory 950) form a computer program product that may be manufactured and/or distributed in accordance with the present disclosure, as is known to those of skill in the art.

The communication interface 940 is also operatively connected to the processor 920 and may be any interface that enables communication between the computing device 900 and other devices, machines and/or elements. The communication interface 940 is configured for transmitting and/or receiving data. For example, the communication interface 940 may include but is not limited to a Bluetooth (®), or cellular transceiver, a satellite communication transmitter/receiver, an optical port and/or any other such, interfaces for wirelessly connecting the computing device 900 to the other devices.

The user interface 910 is also operatively connected to the processor 920. The user interface may comprise one or more input device(s) such as switch(es), button(s), key(s), and a touchscreen.

The user interface 910 functions to facilitate the capture of commands from the user such as an on-off commands or settings related to operation of the system described above. The user interface 910 may function to issue remote instantaneous instructions on images received via a non-local image capture mechanism.

A display 912 may also be operatively connected to the processor 920. The display 912 may include a screen or any other such presentation device that enables the user to view various options, parameters, and results. The display 912 may be a digital display such as an LED display. The user interface 910 and the display 912 may be integrated into a touch screen display.

The computing device 900 may reside on a remote cloud-based computer. In this embodiment, the second vehicle 200 communicates with the computing device 900 via a Vehicle-to-External (V2X) communication capability. Accordingly, the software adapted to implement the system and methods of the present disclosure can also reside in the cloud. Cloud computing provides computation, software, data access and storage services that do not require end-user knowledge of the physical location and configuration of the system that delivers the services. Cloud computing encompasses any subscription-based or pay-per-use service and typically involves provisioning of dynamically scalable and often virtualised resources. Cloud computing providers deliver applications via the Internet, which can be accessed from a web browser, while the business software and data are stored on servers at a remote location.

In another embodiment, as described above, the computing device 900 may be disposed in the second vehicle 200 and the first vehicle 100 communicates with second vehicle 200 via a Vehicle-to-Vehicle (V2V) communication capability. In this embodiment, it will be understood that the computing device 900 corresponds to the computing device 230 as illustrated in FIG. 2.

In the cloud embodiment of the computing device 900, the software modules 960 and processor 920 may be remotely located on the cloud-based computer.

The operation of the computing device 900 and the various elements and components described above will be understood by those skilled in the art with reference to the method and system according to the present disclosure.

The present disclosure is not limited to the embodiment(s) described herein but can be amended or modified without departing from the scope of the present disclosure. Additionally, it will be appreciated that in embodiments of the present disclosure some of the above-described steps may be omitted and/or performed in an order other than that described.

Similarly the words comprises/comprising when used in the specification are used to specify the presence of stated features, integers, steps or components but do not preclude the presence or addition of one or more additional features, integers, steps, components or groups thereof.

1. A method for determining Advanced Driver Assistance Systems (ADAS) features in a first vehicle, the method comprising operating a computing device configured to:
receive one or more identifiers of the first vehicle;
identify the first vehicle based on the one or more identifiers; and
determine from a vehicle database whether the identified first vehicle has ADAS features.

2. The method of claim 1, wherein the computing device resides on a cloud-based computer.

3. The method of claim 1, comprising transmitting the result of determining whether the identified first vehicle has ADAS features to a second vehicle.

4. The method of claim 3, wherein the second vehicle communicates with the computing device via a Vehicle-to-External (V2X) communication capability.

5. The method of claim 1, wherein the computing device is disposed in a second vehicle.

6. The method of claim 5, comprising receiving the result of determining whether the identified first vehicle has ADAS features at the second vehicle.

7. The method of claim 3, wherein the second vehicle is a Highly Autonomous Vehicle (HAV).

8. The method of claim 1, wherein the one or more identifiers comprise one or more of a full or partial vehicle registration number, make, model, and colour of the first vehicle.

9. The method of claim 1, comprising identifying the first vehicle based on a partial vehicle registration number and at least one other identifier comprising a make, model, and colour of the first vehicle.

10. The method of claim 1, comprising identifying the first vehicle as having a specific Vehicle Identification Number (VIN).

11. The method of claim 1, wherein the vehicle database comprises a list of Vehicle Identification Numbers (VIN) cross-referenced to Vehicle Manufacturer Data.

12. The method of claim 11, wherein the vehicle database comprises vehicle makes and models with ADAS attributes.

13. The method of claim 11, wherein the vehicle database comprises vehicle makes and models with no ADAS attributes.

14. The method of claim 3, wherein the second vehicle communicates with the first vehicle via a Vehicle-to-Vehicle (V2V) communication capability.

15. The method of claim 3, wherein the one or more identifiers of the first vehicle are captured using an Automatic Number Plate Recognition (ANPR) imaging device installed in the second vehicle.

16. The method of claim 15, wherein the one or more identifiers comprises a tread-depth of any visible tyre on the first vehicle captured using the ANPR imaging device.

17. The method of claim 1, comprising determining that the identified first vehicle is a Highly Autonomous Vehicle (HAV).

18. The method of claim 1, comprising determining that the identified first vehicle is not a HAV vehicle.

19. The method of claim 18, wherein, it is determined that the first vehicle is equipped with ADAS features.

20. The method of claim 18, wherein, it is determined that the first vehicle is not equipped with ADAS features.

21. A system for determining Advanced Driver Assistance Systems (ADAS) features in a first vehicle, the system comprising:
a vehicle database comprising a list of Vehicle Identification Numbers (VIN) cross-referenced to Vehicle Manufacturer Data; and
a computing device configured to:
receive one or more identifiers of the first vehicle;
identify the first vehicle based on the one or more identifiers; and
determine from the vehicle database whether the identified first vehicle has ADAS features.

22. The system of claim 21, wherein the computing device resides on a cloud-based computer.

23. The system of claim 22, wherein the computing device is configured to transmit the result of determining whether the identified first vehicle has ADAS features to a second vehicle.

24. The system of claim 23, wherein the second vehicle is configured to communicate with the computing device via a Vehicle-to-External (V2X) communication capability.

25. The system of claim 22, wherein the computing device is disposed in a second vehicle.

26. The system of claim 25, wherein the computing device is configured to receive the result of determining whether the identified first vehicle has ADAS features at the second vehicle.

27. The system of claim 23, wherein the second vehicle is a Highly Autonomous Vehicle (HAV).

28. The system of claim 23, wherein the second vehicle communicates with the first vehicle via a Vehicle-to-Vehicle (V2V) communication capability

29. The system of claim 23, comprising an Automatic Number Plate Recognition (ANPR) imaging device installed in the second vehicle, wherein the ANPR imaging device is configured to capture one or more identifiers of the first vehicle.

30. The system of claim 29, wherein the ANPR imaging device is configured to capture one or more of a full or partial vehicle registration number, make, model, colour and a tread-depth of any visible tyre on the first vehicle.

31. The system of claim 22, wherein the vehicle database comprises vehicle makes and models with ADAS attributes.

32. The system of claim 22, wherein the vehicle database comprises vehicle makes and models with no ADAS attributes.

33. The system of claim 21, comprising determining that the identified first vehicle is a Highly Autonomous Vehicle (HAV).

34. The system of claim 21, comprising determining that the identified first vehicle is not a HAV vehicle.

35. The system of claim 34, wherein, it is determined that the first vehicle is equipped with ADAS features.

36. The system of claim 34, wherein, it is determined that the first vehicle is not equipped with ADAS features.
